(19) United States
(12) Patent Application Publication
(10) Pub. No.: US 2006/0215568 A1
(43) Pub. Date: Sep. 28, 2006

(54) System and method for data collection in an avionics network

(75) Inventor: Brian J. Smith, Glendale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/092,470

(22) Filed: Mar. 28, 2005

(51) Int. Cl. H04L 12/56; H04L 12/28; H04L 12/26; H04J 1/16; H04J 3/14; H04L 1/00

(52) U.S. Cl. 370/241; 370/389

(57) ABSTRACT

Systems and methods are provided for data collection in an avionics network. The avionics system comprises a first network switch having an output and a plurality of network inputs and a monitor unit coupled to the output of the first network switch. Each of the plurality of network inputs is configured to couple with a line replaceable unit (LRU). The first network switch is configured to receive a first data from a first LRU via a first network input of the plurality of network inputs of the first network switch, and copy the first data to produce a first copied data. The monitor unit is configured to receive the first copied data from the first network switch. The method comprises the steps of copying the data frames received by a switch from an end system for each of the switches in a deterministic switched network to produce copied data frames at each of the switches in the deterministic switched network, and receiving the copied data frames from a set of switches of the switches in the deterministic switched network at a monitor unit.

### FIELD OF THE INVENTION

The present invention generally relates to deterministic control systems, and more particularly relates to avionics networks.

### BACKGROUND OF THE INVENTION

Avionics systems typically have a variety of components that provide data to other components of the aircraft or exchange data among one or more other components of the aircraft. For example, a variety of external sensors may gather information (e.g., speed, direction, external temperature, and the like) that is routed by the avionics system via an avionics network to one or more aircraft components such as a Line Replaceable Unit (LRU) or a line replaceable module (LRM). The term LRU generally refer to a stand-alone component, and the term LRM generally refers to a module within a larger component. For purposes of simplifying discussion, the term LRU is used herein to include both an LRU and an LRM. In a typical avionics system, the avionics network may have any number of different LRUs connected to the avionics network and operates in a deterministic manner. The term deterministic is used herein to refer to having substantially complete and current data delivered from a source to a receiver in a timely fashion sufficient to meet control system requirements.

In some aircraft systems, the avionics network may be constructed with an Aeronautical Radio INC. (ARINC) 429 data bus capable of supporting communication between many LRUs/LRMs. One function commonly performed in the aircraft is an Aircraft Condition Monitoring Function (ACMF). When performing the ACMF function, substantially all of the data for performing the ACMF function is available on the ARINC 429 data bus, and a simple connection to the ARINC 429 data bus enables retrieval of such data. More recently, Ethernet networks have been used in avionic network environments by leveraging Commercial Off The Shelf (COTS) technology to increase bandwidth and reduce cost.

Ethernet type networks have been used in communication networks for implementing communication among various network components. An Ethernet network may be used to send or route data in a digital form by packets or frames. Each packet contains a set of data, and the packet is generally not interpreted while sent through the Ethernet network. In an avionics network environment, the Ethernet network typically has different equipment (e.g., LRUs and LRMs) that subscribe to the avionics network and connect to each other through switches. Each network subscriber can send packets in digital form, at controlled rates, to one or more other subscribers. When a switch receives the packets, the switch determines the destination equipment and directs or switches the packets to such equipment.

Aeronautical Radio Inc. (ARINC) 664 Part 7 sets forth an aeronautical standard that defines a dual redundant avionics network for use in an aircraft environment and more specifically describes an Avionics Full DupleX (AFDX) switch Ethernet network. In a switched full-duplex Ethernet type network, the term “full-duplex” refers to sending and receiving packets at the same time on the same link, and the term “switched” refers to the packets being switched in switches on appropriate outputs. The AFDX network uses multiple switches and redundant paths to route data, point-to-point or point-to-multipoint across the switches. Additionally, ARINC 664 Part 7 sets forth virtual links or virtual connections in the AFDX network that define a particular routing of information in the AFDX network. However, the AFDX network lacks a common data bus or point, such as the ARINC 429 data bus, for retrieving data to perform the ACMF function or other similar functions. One proposed method is to set forth additional virtual links to duplicate the data for collection, but this method consumes a significant amount of bandwidth and host resources.

Accordingly, it is desirable to provide a deterministic avionics network that provides data collection while minimizing bandwidth consumption. It is also desirable to provide a method for collecting data in a deterministic avionics network that minimizes bandwidth consumption. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An avionics system is provided comprising a first network switch having an output and a plurality of network inputs and a monitor unit coupled to the output of the first network switch. Each of the plurality of network inputs is configured to couple with a line replaceable unit (LRU) or a line replaceable module (LRM). The first network switch is configured to receive a first data from a first LRU via a first network input of the plurality of network inputs of the first network switch, and copy the first data to produce a first copied data. The monitor unit is configured to receive the first copied data from the first network switch.

A method is provided for collecting data from switches in a deterministic switched network, each of the switches configured to receive data frames from end systems. The method comprises the steps of copying the data frames received by a switch from an end system for each of the switches in the deterministic switched network to produce copied data frames at each of the switches in the deterministic switched network; and receiving the copied data frames from a set of switches of the switches in the deterministic switched network at a monitor unit.

An avionics system is provided comprising a first LRU configured to produce a first data, a second LRU configured to produce a second data, a first network switch comprising an output and a first network port coupled to the first LRU and the second LRU, a second network switch comprising an output and a second network port coupled to the first LRU and the second LRU, and a monitor unit coupled to the output of the first network switch and the output of the second network switch. The first network switch is configured to copy the first data from the first LRU to produce a first copied data, and copy the second data from the second LRU to produce a second copied data. The second network switch is configured to copy the first data from the first LRU to produce the first copied data, and copy the second data from the second LRU to produce the second copied data. The monitor unit is configured to receive the first copied data from one of the first network switch and the second network switch, and receive the second copied data from one of the first network switch and the second network switch.

### BRIEF DESCRIPTION OF THE DRAWINGS

The present invention will hereinafter be described in conjunction with the following drawing figures, wherein like numerals denote like elements, and

FIG. 1 is a schematic diagram of an exemplary embodiment of an avionics full duplex switched Ethernet network;

FIG. 2 is a schematic diagram of another exemplary embodiment of an avionics full duplex switched Ethernet network; and

FIG. 3 is a flowchart illustrating an exemplary embodiment of data collection in a deterministic switched network.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

According to various embodiments, a system is provided for data collection in an avionics network. In one exemplary embodiment, the avionics network comprises a first network switch having an output and a plurality of network inputs, and a monitor unit coupled to the output of the first network switch. Each of the plurality of network inputs is configured to couple with a line replaceable unit (LRU), a line replaceable module (LRM), or other aircraft component that collects data. The first network switch is configured to receive a first data from a first LRU/LRM via a first network input of the plurality of network inputs of the first network switch, and copy the first data to produce a first copied data. In this exemplary embodiment, the network switch has a monitor port for coupling to the monitor unit. The network switch monitor port is unidirectional for transmitting frames to the monitor unit, or to a monitor switch as described in greater detail hereinbelow, and thereby does not introduce unplanned packets from the monitor port that may degrade the avionics network. The monitor unit is configured to receive the first copied data from the first network switch. Multiple LRUs/LRMs may be coupled to the avionics network via additional switches. For purposes of simplifying discussion, the term LRU is used hereinbelow to include both an LRU and an LRM.

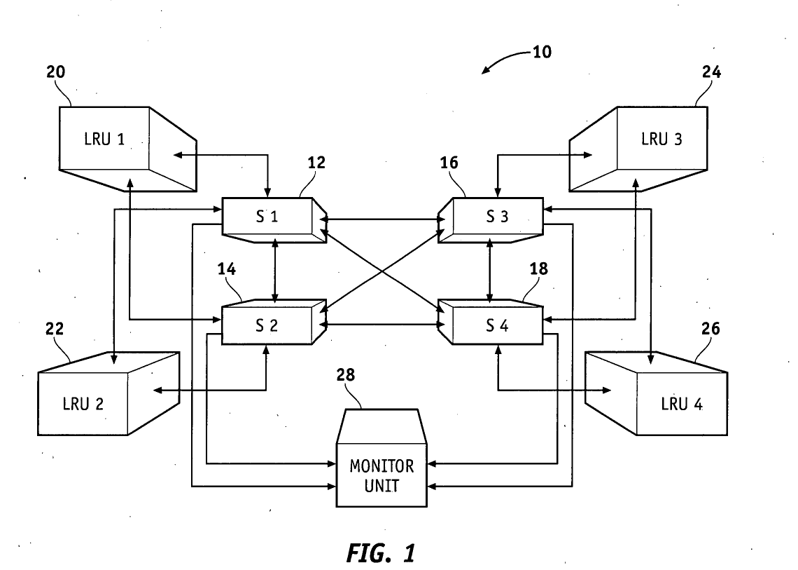

Referring to the drawings, FIG. 1 is a schematic diagram of an exemplary embodiment of an avionics full duplex switched Ethernet network 10. The avionics network 10 is a deterministic Ethernet type network, such as one described in ARINC 664 Part 7, comprising one or more multiport network switches 12, 14, 16, 18, one or more line replaceable units (LRUs) 20, 22, 24, 26 or end systems that are each coupled to one or more of the network switches 12, 14, 16, 18, and a monitor unit 28 coupled to each of the network switches 12, 14, 16, 18 in the avionics network 10. In an exemplary embodiment, the avionics network 10 includes, but is not necessarily limited to, a first LRU 20 (LRU1) coupled to a first network switch 12 (S1) and a second network switch 14 (S2), a second LRU 22 (LRU2) coupled to the first network switch 12 (S1) and the second network switch 14 (S2), a third LRU 24 (LRU3) coupled to a third network switch 16 (S3) and a fourth network switch 18 (S4), and a fourth LRU 26 (LRU4) coupled to the third network switch 16 (S3) and the fourth network switch 18 (S4). Each of the network switches 12, 14, 16, 18 is coupled to the other network switches. While the network 10 is described herein in the context of an avionics environment, the network 10 may also be implemented in other environments using a deterministic Ethernet network.

In a deterministic Ethernet network, data packet delivery follows a bounded arrival distribution, and this bounded arrival distribution generally results in a calculable maximum latency in the network rather than a probabilistic latency. Virtual links having bounded bandwidth and packet delivery intervals may be established in the deterministic Ethernet network between one point in the network and another point in the network. The term virtual link is referred to herein as a connection having a fixed single transfer direction between a single source equipment and one or more destination equipment and having a fixed passband (e.g., maximum number of packets and packet size per second transfer). A network subscriber (e.g., end system or LRU) may have several virtual links. In the avionics network 10, data is preferably sent from point to point or to multipoint via separate virtual links.

In a full-duplex Ethernet network environment (e.g., AFDX), each network component is coupled to a pair of network switches. In the event that a network component does not require network redundancy, such network component may use a single port to connect to a network switch. Although the LRUs 20, 22, 24, 26 are described herein in the context of a redundant configuration, the LRUs 20, 22, 24, 26 may be coupled to a single network switch or to multiple network switches, and the network switches 12, 14, 16, 18 may be coupled to multiple LRUs or end systems. Additionally, although the network switches 12, 14, 16, 18 are described herein as coupled to one another, any variety of coupling configurations may be implemented among the network switches 12, 14, 16, 18. Each of the network switches 12, 14, 16, 18 may be further coupled to various network components such as processors, avionic instruments, and the like. Although not shown in FIG. 1, additional switches, data concentrators, and the like, may also be coupled to each of the network switches 12, 14, 16, 18.

Each network switch has one or more AFDX ports for receiving data frames from a corresponding end system or LRU via a virtual link and one or more Ethernet ports for transferring copied data frames to the monitor unit 28. For example, the first network switch 12 (S1) has a first AFDX port for receiving data frames from the first LRU 20 (LRU1), a second AFDX port for receiving data frames from the second LRU 22 (LRU2), and an Ethernet port coupled to the monitor unit 28. A network switch may use a static configuration table to determine the virtual links associated therewith and an allowable number of packets for a virtual link.

Additionally, each network switch includes, but is not necessarily limited to, a processing core and a memory. The processing core (e.g., Central Processing Unit (CPU)) controls the overall operations of the network switch, and the memory may store data frames during frame forwarding decisions processed by the network switch. Additionally, each network switch may include signal conditioning circuitry and the like as appreciated by those of skill in the art. Each network switch copies all data frames received at a designated AFDX port from an end system or LRU coupled to such AFDX port. The network switch places the copied data frames at an Ethernet port or splits the copied data frames across multiple Ethernet ports based on the bandwidth limits of a virtual link. For example, network switch S1 receives data frames from LRU1 at an AFDX port, copies the data frames received from LRU1, and places the copied data frames at an Ethernet port for retrieval by the monitor unit 28. In the network switch, a media access control (MAC) module may also be coupled to the processing core to perform frame reception and frame transmission associated with transmission along the Ethernet network, such as following Institute of Electrical and Electronics Engineers (IEEE) 802.3 standards which define a Physical and MAC layer of Ethernet.

Each of the LRUs 20, 22, 24, 26 can be any of a variety of devices used in an avionics network environment, such as a sensor, a switch, an avionic instrument, etc. In the avionics full duplex switched Ethernet network 10, an LRU typically has two full duplex Ethernet connections for each processing lane associated therewith and may include signal conditioning circuitry and digital signal processors for transmitting data frames via a virtual link.

The monitor unit 28 may be an LRU that performs a flight data recording application, aircraft monitoring application, or the like. Based on the data recording application or monitoring application operating on the monitor unit 28, the monitor unit 28 retrieves the copied data frames from the Ethernet ports of the network switches 12, 14, 16, 18. Alternatively, the monitor unit 28 may selectively retrieve copied data frames from switches receiving data frames from an appropriate end system or LRU. For example, in the event that the data recording application operating on the monitor unit 28 requires data from the first LRU 20 (LRU1) and the second LRU 22 (LRU2), the monitor unit 28 retrieves the copied data frames from the Ethernet ports of the first network switch 12 (S1) and/or the second network switch 14 (S2).

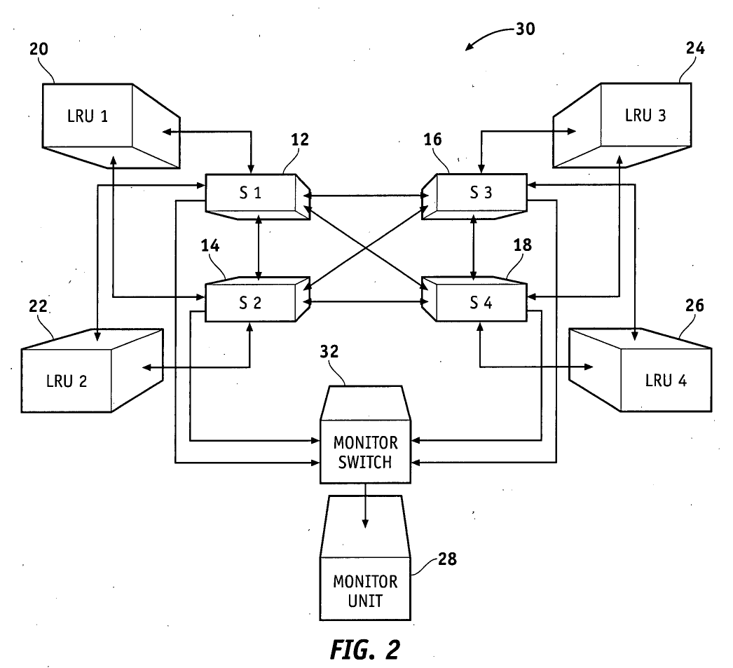

FIG. 2 is a schematic diagram of another avionics full duplex switched Ethernet network 30. As can be seen, this avionics network 30 is similar to the avionics network 10 shown in FIG. 1, and like elements have been denoted with like reference numerals. A monitor switch 32 is coupled to each of the network switches 12, 14, 16, 18 and to the monitor unit 28. The monitor switch 32 receives copied data frames from each of the network switches 12, 14, 16, 18 and transfers the copied data frames to the monitor unit 28. In this exemplary embodiment, a single network switch routes the relevant copied data frames to the monitor unit 28 for use in the data recording application or monitoring application operating on the monitor unit 28.

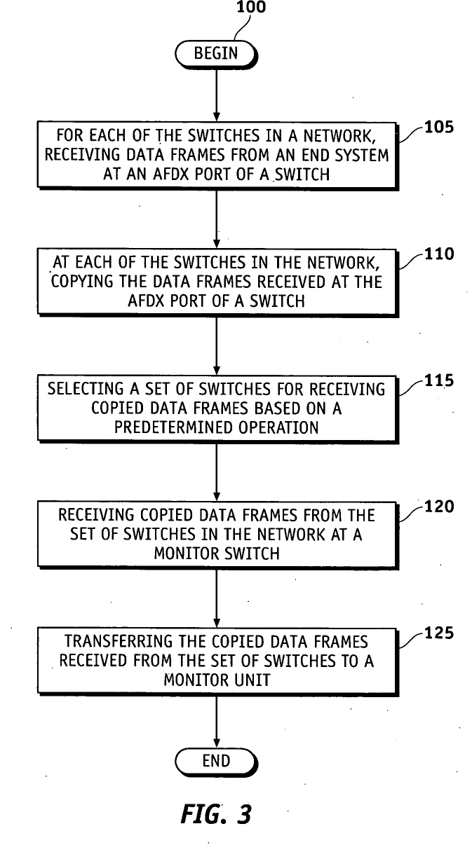

FIG. 3 is a flowchart illustrating an exemplary embodiment of a method for data collection in a deterministic switched network. The method begins at step 100. For each of the network switches 12, 14, 16, 18 of the avionics network 10 shown in FIG. 1, the network switch receives data frames from an end system or LRU at an AFDX port of the network switch at step 105. For each of the network switches 12, 14, 16, 18 of the avionics network 10 shown in FIG. 1, the network switch copies the data frames received at the AFDX port and places the copied data frames at one or more Ethernet ports of the network switch at step 110. The monitor unit 28 shown in FIG. 1 selects a set of network switches from the network switches 12, 14, 16, 18 in the avionics network 10 shown in FIG. 1 for receiving copied data frames based on a pre-determined operation (e.g., data recording application or monitoring application) of the monitor unit 28 at step 115. The set of network switches may include one or more of the network switches 12, 14, 16, 18 of the avionics network 10 shown in FIG. 1. The monitor switch 32 shown in FIG. 1 receives the copied data frames from the set of network switches at step 120. The monitor switch 32 shown in FIG. 1 transfers the copied data frames received from the network switches to the monitor unit 28 shown in FIG. 1 at step 125. In addition, the monitor switch 32 shown in FIG. 1 may discard duplicate, valid frames to reduce the work load of the monitor unit 28 shown in FIG. 1. Alternatively, the monitor unit 28 shown in FIG. 1 directly receives the copied data frames from the set of network switches. Although the method is described in the context of Ethernet, the method may be applied to any deterministic switched network where all of the data does not naturally pass through a common element or bus.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An avionics system comprising:
a first network switch having an output and a plurality of network inputs, each of said plurality of network inputs configured to couple with a line replaceable unit (LRU), said first network switch configured to:
receive a first data from a first LRU via a first network input of said plurality of network inputs of said first network switch; and
copy said first data to produce a first copied data; and
a monitor unit coupled to said output of said first network switch, said monitor unit configured to receive said first copied data from said first network switch.

2. An avionics system according to claim 1 further comprising:
a monitor switch having an input and an output, said input of said monitor switch coupled to said output of said first network switch, said output of said monitor switch coupled to said monitor unit, and said monitor switch configured to transfer said first copied data from said first network switch to said monitor unit.

3. An avionics system according to claim 1 further comprising:
a second network switch having an output coupled to said monitor unit and having a plurality of network inputs, each of said plurality of network inputs of said second network switch configured to coupled with an LRU, said second network switch configured to:
receive a second data from a second LRU via a first network input of said plurality of network inputs of said second network switch; and
copy said second data to produce a second copied data; and
wherein said monitor unit is further configured to receive said second copied data from said second network switch.

4. An avionics system according to claim 3, wherein said first network switch is further configured to:
couple with said second LRU via a second network input of said plurality of network inputs of said first network switch;
receive said second data from said second LRU via said second network input of said plurality of network inputs of said first network switch; and
copy said second data to produce said second copied data;
wherein said second network switch is further configured to:
couple with said first LRU via a second network input of said plurality of network inputs of said second network switch;
receive said first data from said first LRU via said second network input of said plurality of network inputs of said second network switch; and
copy said second data to produce said first copied data.

5. An avionics system according to claim 4, wherein said monitor unit is further configured to:
receive said first copied data from one of said first network switch and said second network switch; and
receive said second copied data from one of said first network switch and said second network switch.

6. An avionics system according to claim 1 further comprising:
a second network switch having an output coupled to said monitor unit and having a plurality of network inputs, each of said plurality of network inputs of said second network switch configured to couple with an LRU, said second network switch configured to:
receive said first data from said first LRU via a first network input of said plurality of network inputs of said second network switch; and
copy said first data to produce said first copied data; and
wherein said monitor unit is further configured to receive said first copied data from one of said first network switch and said second network switch.

7. An avionics system according to claim 6, wherein each of said first network switch and said second network switch comprises an Avionics Full Duplex Network (AFDX) switch.

8. An avionics system according to claim 3, wherein said first network switch is coupled to said second network switch.

9. A method for collecting data from switches in a deterministic switched network, each of the switches configured to receive data frames from end systems, the method comprising the steps of:
copying the data frames received by a switch from an end system for each of the switches in the deterministic switched network to produce copied data frames at each of the switches in the deterministic switched network; and
receiving the copied data frames from a set of switches of the switches in the deterministic switched network at a monitor unit.

10. A method for collecting data according to claim 9, wherein said receiving step comprises:
receiving the copied data frames from the set of switches at a monitor switch; and
transferring the copied data frames received at the monitor switch to the monitor unit.

11. A method for collecting data according to claim 9, wherein said copying step comprises the steps of:
receiving the data frames from the end system at an AFDX port of a switch for each of the switches in the deterministic switched network; and
copying the data frames received at the AFDX port of a switch at each of the switches in the deterministic switched network.

12. A method for collecting data according to claim 9, wherein said receiving step comprises the step of:
receiving the copied data frames from a first Ethernet port of each of the switches in the set of switches at the monitor unit.

13. A method for collecting data according to claim 12, wherein said receiving step comprises the step of:
receiving the copied data frames at the monitor unit from a second Ethernet port of at least one of the switches in the set of switches.

14. A method for collecting data according to claim 9 further comprising the step of:
selecting the set of switches from the switches in the deterministic switched network based on a predetermined operation of the monitor unit.

15. A method for collecting data according to claim 9, wherein the set of switches comprises all of the switches in the deterministic network.

16. An avionics system comprising:
a first LRU configured to produce a first data;
a second LRU configured to produce a second data;
a first network switch comprising an output and a first network port, said first network port coupled to said first LRU and said second LRU, said first network switch configured to:
copy said first data from said first LRU to produce a first copied data; and
copy said second data from said second LRU to produce a second copied data;
a second network switch comprising an output and a second network port, said second network port coupled to said first LRU and said second LRU, said second network switch configured to:
copy said first data from said first LRU to produce said first copied data; and
copy said second data from said second LRU to produce said second copied data; and
a monitor unit coupled to said output of said first network switch and said output of said second network switch, said monitor unit configured to:
receive said first copied data from one of said first network switch and said second network switch; and
receive said second copied data from one of said first network switch and said second network switch.

17. An avionics system according to claim 16, wherein each of said first network switch and said second network switch comprises an AFDX switch.

18. An avionics system according to claim 16, wherein said first network switch is coupled to said second network switch.

19. An avionics system according to claim 16, wherein said first network switch further comprises a first Ethernet port;
wherein said second network switch further comprises a second Ethernet port; and
wherein said monitor unit is coupled to said first Ethernet port and said second Ethernet port, and said monitor unit further configured to:
receive said first copied data from one of said first Ethernet port and said second Ethernet port; and
receive said second copied data from one of said first Ethernet port and said second Ethernet port.

20. An avionics system according to claim 19 further comprising:
a monitor switch having an input and an output, said input of said monitor switch coupled to said first Ethernet port and said second Ethernet port, said output of said monitor switch coupled to said monitor unit, and said monitor switch configured to:
transfer said first copied data from one of said first network switch and said second network switch to said monitor unit; and
transfer said second copied data from one of said first network switch and said second network switch to said monitor unit.
